(19) United States
(12) Patent Application Publication
(10) Pub. No.: US 2026/0143413 A1
(43) Pub. Date: May 21, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Qufang HUANG, Shanghai (CN); Jin LIU, Shanghai (CN)

(21) Appl. No.: 19/443,770

(22) Filed: Jan. 8, 2026

Related U.S. Application Data
(63) Continuation of application No. PCT/CN2024/090974, filed on Apr. 30, 2024.

(51) Int. Cl. H04W 48/08; H04L 1/18

(52) U.S. Cl. CPC H04W 48/08; H04L 1/18

(57) ABSTRACT

Disclosed are a wireless communication method, a terminal device, and a network device. The method includes: determining, by a terminal device, whether to transmit a first request, wherein the first request is used to request a network device to transmit a system information block 1 (SIB1), and the first request is associated with first information, and the first information is used for one or more of following: determining a transmission manner of the SIB1; determining a transmission resource for transmitting the first request; or determining sequence information of the first request.

### CROSS-REFERENCE TO RELATED APPLICATIONS

This application is a continuation of International Application No. PCT/CN2024/090974, filed on Apr. 30, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

In a conventional communications system, a network device periodically transmits system information block (system information blocks, SIB) 1. A terminal device cannot ensure that each transmitted SIB1 is effectively used. This may cause a waste of resources.

### SUMMARY

Provided in the present application are a wireless communication method, a terminal device, and a network device. Various aspects involved in the present application are described below.

According to a first aspect, a wireless communication method is provided, including: determining, by a terminal device, whether to transmit a first request, where the first request is used to request a network device to transmit a system information block SIB1, where the first request is associated with first information, and the first information is used for one or more of the following: determining a transmission manner of the SIB1; determining a transmission resource for transmitting the first request; or determining sequence information of the first request.

According to a second aspect, a wireless communication method is provided, including: receiving, by a network device, a first request transmitted by a terminal device, where the first request is used to request a network device to transmit a system information block SIB1, where the first request is associated with first information, and the first information is used for one or more of the following: determining a transmission manner of the SIB1; determining a transmission resource for transmitting the first request; or determining sequence information of the first request.

According to a third aspect, a terminal device is provided, including: a determining unit, determining whether to transmit a first request, where the first request is used to request a network device to transmit a system information block SIB1, where the first request is associated with first information, and the first information is used for one or more of the following: determining a transmission manner of the SIB1; determining a transmission resource for transmitting the first request; or determining sequence information of the first request.

According to a fourth aspect, a network device is provided, including: a receiving unit, receiving a first request transmitted by a terminal device, where the first request is used to request the network device to transmit a system information block SIB1, where the first request is associated with first information, and the first information is used for one or more of the following: determining a transmission manner of the SIB1; determining a transmission resource for transmitting the first request; or determining sequence information of the first request.

According to a fifth aspect, a terminal device is provided, including a processor, a memory, and a communications interface. The memory is configured to store one or more computer programs, and the processor is configured to invoke the computer program in the memory, to cause the terminal device to perform a part or all of the steps of the method in the first aspect.

According to a sixth aspect, a network device is provided, including a processor, a memory, and a transceiver. The memory is configured to store one or more computer programs, and the processor is configured to invoke the computer program in the memory, to cause the network device to perform a part or all of the steps in the method in the second aspect.

According to a seventh aspect, an embodiment of the present application provides a communications system. The system includes the foregoing terminal device and/or the foregoing network device. In another possible design, the system may further include another device that interacts with the terminal device or the network device in the solutions provided in embodiments of the present application.

According to an eighth aspect, an embodiment of the present application provides a computer-readable storage medium. The computer-readable storage medium stores a computer program. The computer program causes a communications device (for example, a terminal device or a network device) to perform a part or all of the steps in the method in the foregoing aspects.

According to a ninth aspect, an embodiment of the present application provides a computer program product. The computer program product includes a non-transitory computer-readable storage medium that stores a computer program. The computer program is operable to cause a communications device (for example, a terminal device or a network device) to perform a part or all of the steps in the method in the foregoing aspects. In some implementations, the computer program product may be a software installation package.

According to a tenth aspect, an embodiment of the present application provides a chip. The chip includes a memory and a processor. The processor may invoke a computer program from the memory and run the computer program, to implement a part or all of the steps in the method in the foregoing aspects.

In embodiments of the present application, the terminal device may determine whether to transmit the first request. The first request is used to request the network device to transmit the SIB1. The first request is associated with the first information. The first information may be used for determining the transmission manner of the SIB1, and/or related configuration information for transmitting the first request (for example, the configuration information is used to configure the transmission resource for transmitting the first request, and/or the sequence information for transmitting the first request). Compared with periodic transmission of the SIB1 in conventional solutions, the terminal device may determine whether transmission of the SIB1 needs to be triggered by transmitting the first request, which facilitates reducing a quantity of SIB1s that are not effectively used, thereby improving utilization of transmission resources.

### BRIEF DESCRIPTION OF DRAWINGS

FIG. 1 shows a wireless communications system 100 to which an embodiment of the present application is applied.

FIG. 2A is a schematic diagram of a SIB transmission procedure.

FIG. 2B is a schematic diagram of another SIB transmission procedure.

FIG. 3 is a schematic diagram of determining common control information resource set (control-resource set, CORESET) information based on a master information block (master information block, MIB).

FIG. 4 is a schematic flowchart of a wireless communication method according to an embodiment of the present application.

FIG. 5 is a diagram of an example in which first information is predefined information.

FIG. 6 is a diagram of an example in which first information includes first system information.

FIG. 7 is a diagram of an example of a combination solution of Embodiment 2 and Embodiment 4 of first information.

FIG. 8 is a diagram of an example of a combination solution of Implementation 1-1 and Embodiment 2 of first information.

FIG. 9 is a schematic flowchart of transmitting a first request and receiving a SIB1.

FIG. 10 is a schematic diagram of a terminal device according to an embodiment of the present application.

FIG. 11 is a schematic diagram of a network device according to an embodiment of the present application.

FIG. 12 is a schematic diagram of a structure of a communications apparatus according to an embodiment of the present application.

### DESCRIPTION OF EMBODIMENTS

The technical solutions in the present application are described below with reference to the accompanying drawings.

### Architecture of a Communications System

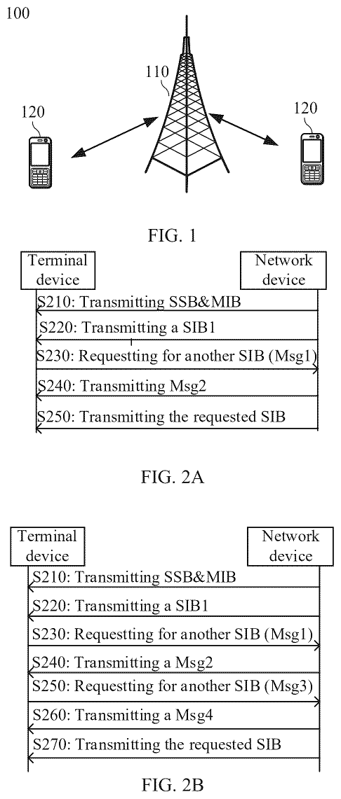

FIG. 1 shows a wireless communications system 100 to which an embodiment of the present application is applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (5th generation, 5G) system or a new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in the present application may further be applied to a future communications system, such as a 6th generation mobile communications system or a satellite communications system.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

A network device in embodiments of the present application may be a device for communicating with the terminal device. The network device may also be referred to as an access network device or a radio access network device. For example, the network device may be a base station. The network device in embodiments of the present application may be a radio access network (radio access network, RAN) node (or device) that connects the terminal device to a wireless network. The base station may broadly cover the following various names, or may be interchanged with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode MeNB, a secondary eNode SeNB, a multi-standard radio (MSR) node, a home base station, a network controller, an access node, a radio node, an access point (access point, AP), a transmission node, a transceiver node, a baseband unit (baseband unit, BBU), a remote radio unit (Remote Radio Unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

### SIB

With popularization of cellular networks, a power consumption problem is becoming increasingly prominent to operators. For example, in comparison with LTE, because a relatively high frequency is usually used in a 5G network, signal attenuation is relatively large, and a geographical area covered by each cell is smaller. Therefore, more cells are needed, causing higher power consumption. In addition, because a system message is transmitted in a beam sweeping (beam sweeping) manner in 5G, a SIB is transmitted once on all beams, and power consumption is much higher than that in LTE.

The SIB is used by a network device to transfer important network parameters and configuration information to a terminal device. A SIB1 carries the most critical information needed by the terminal device to access a cell, for example, a random access parameter. The SIB1 includes information about availability and scheduling of system information (for example, a SIB2) other than the SIB1. In some implementations, system information other than the SIB1 is referred to “other SIB”.

In a conventional communications system, the SIB1 is periodically transmitted by the network device, and another SIB (for example, the SIB2 or a SIB3) is transmitted based on a request of the terminal device. After the terminal device reads the SIB1, if the terminal device wants to further read other SIB information, the terminal device requests the network device to transmit the other SIB information. The network device does not transmit another SIB message unless the network device is requested to do so.

The following describes a process of transmitting a SIB in a conventional communications system with reference to FIG. 2A and FIG. 2B.

FIG. 2A is a process in which a terminal device requests another SIB by using a message 1 (Msg1) in a random access process. FIG. 2A includes step S210 to step S250.

In step S210, periodically transmitting, by a network device (for example, a gNB) of a cell in which a terminal device (for example, UE) is located, a synchronization signal/physical broadcast channel block (synchronization signal block/physical broadcast channel block, SS/PBCH block, SSB), where a MIB is carried by using a physical broadcast channel (physical broadcast channel, PBCH) of the SSB.

In step S220, periodically transmitting, by the network device, a SIB1, so that the terminal device performs measurement during initial access and obtains basic information of the cell, for example, a physical random access channel (physical random access channel, PRACH).

In step S230, requesting, by the terminal device, another SIB from the network device by using a random access message 1.

In some implementations, because a preamble (preamble) is transmitted in the random access message 1, the message 1 may also be referred to as a “preamble”.

In step S240, transmitting, by the network device, a message 2 (Msg2) to the terminal device.

In step S250, transmitting, by the network device, to the terminal device, another SIB requested by the terminal device in the Msg1.

FIG. 2B is a process in which a terminal device requests another SIB by using a Msg1 and a message 3 (Msg3) in a random access process. FIG. 2B includes step S210 to step S250.

Step S210 to step S240 in FIG. 2B are the same as step S210 to step S240 in FIG. 2A. Details are not described herein again. Step S250 to step S270 in FIG. 2B are described below.

In step S250, requesting, by the terminal device, another SIB from the network device by using the Msg3.

In step S260, transmitting, by the network device, a message 4 (Msg4) to the terminal device.

In step S370, transmitting, by the network device, to the terminal device, a SIB requested by the terminal device.

Alternatively, system information other than the SIB1 is requested from a base station by using the message 3 (Msg3). Refer to FIG. 2A and FIG. 2B.

FIG. 2A and FIG. 2B show a process of requesting a SIB between a terminal device and a network device. The following provides content of a MIB provided by a radio resource control (radio resource control, RRC) layer.

MIB ::= SEQUENCE {
systemFrameNumber BIT STRING (SIZE (6)),
subCarrierSpacingCommon ENUMERATED {scs15or60, scs30or120},
ssb-SubcarrierOffset INTEGER (0...15),
dmrs-TypeA-Position ENUMERATED {pos2, pos3},
pdcch-ConfigSIB1 INTEGER (0...255),
cellBarred ENUMERATED {barred, notBarred},
intraFreqReselection ENUMERATED {allowed, notAllowed},
spare BIT STRING (SIZE (1))
}

Content of a MIB provided by a physical layer is as follows:
system frame number (system frame number, SFN) [24:27]: lower bits of a 10 ms system frame number;
Hfn [28]: 5 ms half frame number, 0 or 1; and
SSB most significant bits (most significant bit, MSB) [29:31]: 3-bit beam identifier, used to identify 64 different beams with eight sequences (3 bits) of a demodulation reference signal (demodulation reference signal, DMRS).

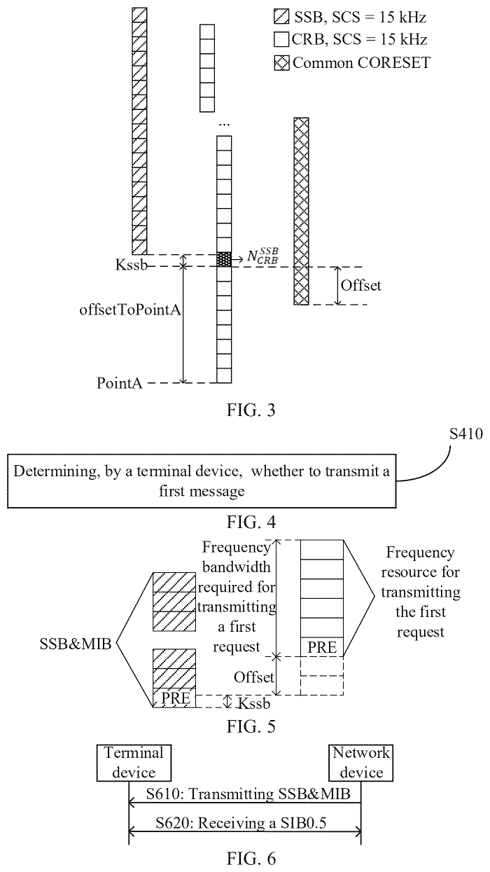

In the foregoing, information such as a time-frequency resource required for transmitting the Msg1 by the terminal device and a random access code needs to be obtained by using the SIB1. After finding the MIB, the terminal device obtains Kssb based on the parameter SSB-SubcarrierOffset in the MIB, to obtain a frequency domain location of an uplink symbol or a downlink symbol of the cell, that is, an index N_{CRB}^{SSB} in FIG. 3. Then, the terminal device obtains common CORESET information based on the parameter PDCCH-ConfigSIB1 in the MIB. Content of the PDCCH-ConfigSIB1 is as follows:

```
PDCCH-ConfigSIB1 ::= SEQUENCE {
  controlResourceSetZero ControlResourceSetZero,
  searchSpaceZero SearchSpaceZero
}
```

The terminal device may determine a frequency domain configuration such as a symbol quantity and an Offset in FIG. 3 based on ControlResourceSetZero of PDCCH-ConfigSIB1, and may determine a time domain-related configuration such as an SFN and a slot index based on SearchSpaceZero of PDCCH-ConfigSIB1.

After obtaining the common CORESET information, the terminal device blindly detects downlink control information (downlink control information, DCI) by using a system information radio network temporary identifier (system information radio network temporary identifier, SI-RNTI) in a common CORESET, and finally reads the SIB1 based on a DCI indication.

For a frequency range (frequency range, FR) 1, a value range of Kssb is 0-11. Therefore, values 0-11 of the parameter SSB-SubcarrierOffset are used to indicate Kssb, and values 12-15 are invalid code points (hereinafter also referred to as invalid values). For an FR 2, a value range of Kssb is 0-23. Therefore, the parameter SSB-SubcarrierOffset and 1 bit of an SSB MSB, 5 bits in total, are used to indicate Kssb, where 0-23 are valid code points (hereinafter also referred to as valid values), and 24-31 are invalid code points. The terminal device determines Kssb based on the frequency range FR 1 or FR 2 of the current cell, and determines a next operation based on a value of Kssb. If Kssb is a valid code point, the terminal device considers that PDCCH-ConfigSIB1 indicates the common CORESET information, and the terminal device reads the SIB1 in the common CORESET. If Kssb is an invalid code point, the terminal device considers that PDCCH-ConfigSIB1 indicates frequency information of the SIB1, and the terminal device may switch to the frequency, search for an SSB, read a MIB, and read the SIB1.

As described above, in the conventional communications system, the network device periodically transmits the SIB1, while the terminal device cannot ensure that each transmitted SIB1 is effectively used, which may cause a waste of resources.

For the foregoing problem, in some known solutions, the terminal device may trigger transmission of the SIB1 based on a request (hereinafter also referred to as a “first request”), that is, the terminal device may trigger transmission of the SIB1 based on the first request according to a requirement of the terminal device. For example, if the terminal device needs the SIB1, the terminal device may transmit the first request to the network device to trigger transmission of the SIB1. If the terminal device does not need the SIB1, the terminal device may not transmit the first request to the network device. In some scenarios, this transmission manner of the SIB1 may also be referred to as on demand (on demand) transmission of the SIB1. Compared with periodic transmission of the SIB1 in conventional solutions, the solution of the on demand transmission of the SIB1 facilitates reducing a quantity of SIB1s that are not effectively used, to improve utilization of transmission resources. However, how to transmit the first request is an urgent problem to be resolved.

Therefore, for the foregoing problem, in this embodiment of the present application, first information associated with the first request is introduced, to facilitate assisting, by using the first information, the terminal device in determining whether to transmit the first request, and/or assisting, by using the first information, the terminal device in determining how to transmit the first request. With reference to FIG. 4, the following describes a wireless communication method according to an embodiment of the present application. FIG. 4 is a schematic flowchart of a wireless communication method according to an embodiment of the present application. The method shown in FIG. 4 includes step S410.

In step S410, determining, by a terminal device, whether to transmit a first request, where the first request is used to request a network device to transmit a SIB1.

In some implementations, the first information is used for determining a transmission manner of the SIB1. For example, the first information may carry information used to indicate the transmission manner of the SIB1. For another example, the first information may indirectly indicate the transmission manner of the SIB1 by using other information carried in the first information, to facilitate reducing overheads of transmitting the first information.

In some implementations, the transmission manner of the SIB1 may include triggering transmission of the SIB1 based on a request of the terminal device, or triggering transmission of the SIB1 based on the first request, that is, the foregoing described solution of on demand transmission of the SIB1.

In some implementations, if the network device transmits the SIB1 in an “on demand (on demand)” manner, the SIB1 may also be correspondingly referred to as an “on demand SIB1”.

In some implementations, the transmission manner of the SIB1 may include triggering transmission of the SIB1 based on a periodicity.

In some other implementations, the first information is used for determining a transmission resource for transmitting the first request and determining sequence information of the first request.

In this embodiment of the present application, the transmission resource is not limited. In some implementations, the transmission resource may include one or more of the following: a time resource, a frequency resource, or a code resource. For example, the transmission resource includes a time resource. The time resource may include a symbol, a slot, a subframe, a frame, and the like. Certainly, in this embodiment of the present application, the transmission resource may further include another time resource introduced in a future communications system. For example, the transmission resource includes a frequency resource. The frequency resource may include a subcarrier, a frequency band, a bandwidth, and the like. Certainly, in this embodiment of the present application, the frequency resource may further include another frequency resource introduced in a future communications system. For example, the transmission resource includes a code resource. The code resource may include a codebook, a codeword, and the like. Certainly, in this embodiment of the present application, the code resource may further include another code resource introduced in a future communications system.

In this embodiment of the present application, the first information may be implemented in a plurality of manners. With reference to Embodiment 1 to Embodiment 6, the following describes the first information in embodiments of the present application.

Embodiment 1: The first information includes a first parameter.

In some implementations, the first parameter is used for determining the transmission manner of the SIB1.

In some implementations, the first parameter is used to indicate a frequency domain offset between a transmission resource of an SSB and a reference resource. For example, the first parameter is Kssb, the reference resource is

$${N}_{C R B}^{S S B} ,$$

Kssb is used for determining the frequency domain offset between the transmission resource of the SSB and N_{CRB}^{SSB}, and Kssb is carried in a parameter SSB-SubcarrierOffset of a MIB. Certainly, in this embodiment of the present application, the first parameter may also be used to indicate other information.

In some implementations, a value of the first parameter may be one or more predefined or preconfigured values. For example, the first parameter is Kssb, and a value of Kssb included in the first information is defined as one or more values in invalid values according to a protocol.

Implementation 1-1: The first information includes one value of the first parameter.

In some implementations, the value of the first parameter is an invalid value, and the transmission manner of the SIB1 is triggering transmission of the SIB1 based on the request of the terminal device. For example, the first parameter is Kssb. For the FR 1, as defined in a protocol, if the value of Kssb is one or more specific values in 12-15, for example, 12, the terminal device considers that the transmission manner of the SIB1 is triggering transmission of the SIB1 based on the request of the terminal device. For the FR 2, as defined in a protocol, if the value of Kssb is one or more specific values in 24-31, for example, 24, the terminal device considers that the transmission manner of the SIB1 is triggering transmission of the SIB1 based on the request of the terminal device. In this embodiment of the present application, the first information may be indicated by using an invalid value of Kssb, so that the first information may reuse a known field of the MIB, which facilitates simplifying a design.

In some implementations, if the value of the first parameter is a valid value, the transmission manner of the SIB1 is triggering transmission of the SIB1 based on a periodicity. For example, the first parameter is Kssb. For the FR 1, as defined in a protocol, if the value of Kssb is one or more specific values in 0-11, for example, 5, the terminal device considers that the transmission manner of the SIB1 is triggering transmission of the SIB1 based on the periodicity. For the FR 2, as defined in a protocol, if the value of Kssb is one or more specific values in 0-23, for example, 20, the terminal device considers that the transmission manner of the SIB1 is triggering transmission of the SIB1 based on the periodicity.

In some implementations, if the value of the first parameter is an invalid value, the first information includes a second parameter that is in a MIB and that is used for configuring the SIB1, and the second parameter is used for determining the transmission resource for transmitting the first request, and/or determining the sequence information of the first request. For example, the first parameter is Kssb, and the second parameter is pdcch-ConfigSIB1. If the value of Kssb is an invalid value, the parameter pdcch-ConfigSIB1 of the MIB may be used for determining the transmission resource for transmitting the first request, and/or determining the sequence information of the first request.

In some implementations, if the value of the first parameter is an invalid value, the transmission resource of the first request is aligned with the transmission resource of the SSB in time domain or frequency domain. For example, the transmission resource is a physical resource element (physical resource element, PRE), and the first parameter is Kssb. If the value of Kssb is an invalid value, a PRE for transmitting the first request is aligned with a PRE for transmitting the SSB in frequency domain. In other words, at a level of a PRE grid, the transmission resource of the first request is aligned with the transmission resource of the SSB in frequency domain.

Implementation 1-2: The first information includes a plurality of values of the first parameter.

In some implementations, the first parameter belongs to one of a plurality of first parameters obtained by the terminal device. If the plurality of first parameters have different values, it may be determined that the transmission manner of the SIB1 is triggering transmission of the SIB1 based on the request of the terminal device. It should be noted that the plurality of values of the first parameter are obtained by the terminal device by receiving the first parameter for a plurality of times, and the value of the first parameter each time the terminal device receives the first parameter may be one value.

In some implementations, the plurality of values of the first parameter are different valid values. For example, the first parameter is Kssb. For the FR 1, if values of Kssb is a plurality of values in 0-11, for example, 3 and 5, it may be determined that the transmission manner of the SIB1 is triggering transmission of the SIB1 based on the request of the terminal device. For the FR 2, if values of Kssb is a plurality of values in 0-23, for example, 12 and 18, it may be determined that the transmission manner of the SIB1 is triggering transmission of the SIB1 based on the request of the terminal device.

In some implementations, if the value of the first parameter is a valid value, the first information includes a second parameter that is in a MIB and that is used for configuring the SIB1, and the second parameter is used for determining the transmission resource for transmitting the first request, and/or determining the sequence information of the first request. For example, the first parameter is Kssb, and the second parameter is the parameter pdcch-ConfigSIB1 of the MIB. If the value of Kssb is a valid value, pdcch-ConfigSIB1 may be used for determining the transmission resource for transmitting the first request, and/or determining the sequence information of the first request.

In some implementations, if the value of the first parameter is a valid value, the transmission resource of the first request is aligned with a transmission resource of uplink data or downlink data in time domain or frequency domain. For example, the transmission resource is a PRE, and the first parameter is Kssb. If the value of Kssb is a valid value, a PRE of the first request is aligned with a PRE of the uplink data or the downlink data in frequency domain. In other words, at a level of a PRE grid, the transmission resource of the first request is aligned with the transmission resource of the uplink data or the downlink data in frequency domain.

In some implementations, the transmission resource of the uplink/downlink data may be determined based on the second parameter. For example, the first parameter is Kssb, and the second parameter is the parameter pdcch-ConfigSIB1 of the MIB. If the value of Kssb is a valid value, the DCI may be blindly detected based on common CORESET information indicated by pdcch-ConfigSIB1. Because the DCI may schedule the transmission resource of the uplink data or the downlink data, the transmission resource of the uplink data or the downlink data may be determined based on the second parameter, and the transmission resource of the first request is further determined.

In some implementations, the plurality of values of the first parameter are different invalid values. For example, the first parameter is Kssb. For the FR 1, if values of Kssb is a plurality of values in 12-15, for example, 13 and 14, it may be determined that the transmission manner of the SIB1 is triggering transmission of the SIB1 based on the request of the terminal device. For the FR 2, if values of Kssb is a plurality of values in 24-31, for example, 25 and 30, it may be determined that the transmission manner of the SIB1 is triggering transmission of the SIB1 based on the request of the terminal device. The transmission manner of the SIB1 is determined based on the plurality of invalid values of Kssb. A known field may be reused. This facilitates simplifying a design.

In some implementations, if the value of the first parameter is an invalid value, a related solution in Implementation 1-1 above is also applicable to this implementation. Details are not described herein again.

Embodiment 2: The first information is used to indicate a duration of a first timer.

In some implementations, the first timer is used to record a duration in which the terminal device monitors the SIB1. For example, the first timer may be represented as “T_sib1”.

In some implementations, the duration of the first timer is predefined. For example, the protocol specifies the duration of the first timer T_sib1. Certainly, in this embodiment of the present application, the duration of the first timer may be preconfigured or configured by the network device.

In this embodiment of the present application, a value of the duration of the first timer is not limited. For example, the duration of the first timer may be 0.

In some implementations, during running of the first timer, if the terminal device detects the SIB1, the SIB1 may be a SIB1 requested by another terminal device on demand. In other words, the SIB1 detected by the terminal device is the SIB1 requested by the another terminal device by transmitting a first request. For example, a second terminal device transmits a first request, and the network device receives the first request and transmits a first SIB1. In a period in which the first timer T_sib1 is started, the first terminal device may monitor the first SIB1 requested by the second terminal device on demand. If the first terminal device detects the first SIB1 requested by the second terminal device on demand, the first terminal device may no longer transmit the first request, to facilitate reducing overheads of transmitting the first request and further reduce power consumption of the first terminal device. In addition, the solution also facilitates reducing interference caused due to a plurality of transmitted first requests.

In another implementation, during running of the first timer, the SIB1 monitored by the terminal device may be a periodically transmitted SIB1. For example, in the period in which the first timer T_sib1 is started, the network device periodically transmits the SIB1. Correspondingly, the terminal device may monitor the SIB1.

In some implementations, start of the first timer is triggered based on the MIB read by the terminal device. For example, the terminal device receives the SSB, reads the MIB carried in the SSB, and starts the first timer T_sib1 once the MIB is read.

In some implementations, start of the first timer is triggered based on the value of the first parameter.

For related explanations of the first parameter, refer to Embodiment 1. Details are not described herein again.

In some implementations, the first parameter is used to indicate a frequency domain offset between a transmission resource of an SSB and a reference resource. For example, the first parameter is Kssb, and/or the reference resource is

$${N}_{C R B}^{S S B} ,$$

where Kssb is used for determining the frequency domain offset between the transmission resource of the SSB and

$${N}_{C R B}^{S S B} ,$$

of Kssb is a valid value, the first timer T_sib1 is started. Certainly, in this embodiment of the present application, when the value of Kssb is an invalid value, the first timer T_sib1 may also be started.

In some implementations, the first timer is associated with a first frequency range. In other words, the first timer is configured at the granularity of a frequency range.

In some implementations, the first frequency range belongs to a plurality of frequency ranges, and durations of first timers associated with different frequency ranges in the plurality of frequency ranges are different. For example, the plurality of frequency ranges include the FR 1 and the FR 2, and a duration of a first timer associated with the FR 1 is different from a duration of a first timer associated with the FR 2. Certainly, in this embodiment of the present application, durations of first timers associated with different frequency ranges in the plurality of frequency ranges may be the same. For example, the plurality of frequency ranges include the FR 1 and the FR 2, and a duration of a first timer associated with the FR 1 is different from a duration of a first timer associated with the FR 2.

In some implementations, the transmission manner of the SIB1 may be determined based on the duration of the first timer. For example, if the terminal device does not detect the SIB1 during running of the first timer, it is determined that the transmission manner of the SIB1 is triggering transmission of the SIB1 based on the request of the terminal device. If the terminal device detects the SIB1 during running of the first timer, the transmission manner of the SIB1 may be triggering transmission of the SIB1 based on the request of the terminal device, or triggering transmission of the SIB1 based on the periodicity.

For ease of understanding, by using an example in which the first parameter is Kssb, the following describes a solution in which the first information indicates the duration of the first timer.

It is assumed that the first timer is T_sib1, the first information indicates the duration of T_sib1, and the first parameter is Kssb. The terminal device reads the MIB, determines, based on the parameter SSB-SubcarrierOffset of the MIB, that the value of Kssb is a valid value, obtains the common CORESET information based on the parameter pdcch-ConfigSIB1 of the MIB, and starts T_sib1. During running of T_sib1, the terminal device monitors, based on an SI-RNTI, DCI indicated by the common CORESET information, to monitor the SIB1. If the terminal device detects the SIB1, T_sib1 is stopped, and the SIB1 is read. The terminal device determines that the first request does not need to be transmitted. If T_sib1 expires, it is determined that the transmission manner of the SIB1 is triggering transmission of the SIB1 based on the request of the terminal device.

Embodiment 3: The first information is carried in a dedicated field of the MIB.

In some implementations, the dedicated field of the MIB may be understood as a field, in the MIB, dedicated to carrying the first information. In other words, the first information may be a newly introduced parameter in the dedicated field. For example, the dedicated field may be a reserved bit of the MIB. For example, if a value of the reserved bit of the MIB is a first value, it indicates that the transmission manner of the SIB1 is triggering transmission of the SIB1 based on the request of the terminal device, and the terminal device may determine to transmit the first request. If a value of the reserved bit of the MIB is a second value, it indicates that the transmission manner of the SIB1 is triggering transmission of the SIB1 based on the periodicity, and the terminal device may determine not to transmit the first request. The first value is different from the second value. For example, the first value may be 0, and the second value may be 1. For another example, the first value may be 1, and the second value may be 0. The first information is carried by using the dedicated field of the MIB, which facilitates improving flexibility of transmitting the first information.

Embodiment 4: The first information is predefined information.

In some implementations, the first information is used for determining the transmission resource for transmitting the first request, and/or determining the sequence information of the first request. In other words, the transmission resource for transmitting the first request, and/or the sequence information of the first request may be determined based on predefined information.

In some implementations, the first information is used to indicate one or more of the following: a frequency domain spacing between a frequency resource of the SSB and a frequency resource of the first request; a transmission periodicity of the first request; a time resource for transmitting the first request; or a frequency bandwidth required for transmitting the first request.

In this embodiment of the present application, the frequency domain spacing between the frequency resource of the SSB and the frequency resource of the first request is not limited. In some implementations, the frequency domain spacing may be a frequency domain spacing between a lower limit PRE of the SSB in the cell (that is, a PRE corresponding to the lowest frequency in the PRE of the SSB) and a lower limit PRE of the first request (that is, a PRE corresponding to the lowest frequency in a PRE of the first request). In some other implementations, the frequency domain spacing may be a frequency domain spacing between a lower limit PRE of the SSB in the cell and an upper limit PRE of the first request (that is, a PRE corresponding to the highest frequency in a PRE of the first request). In some other implementations, the frequency domain spacing may be a frequency domain spacing between an upper limit PRE of the SSB (that is, a PRE corresponding to the highest frequency in a PRE of the SSB) and a lower limit PRE of the first request. In some other implementations, the frequency domain spacing may be a frequency domain spacing between an upper limit PRE of the SSB of the cell and an upper limit PRE of the first request.

In some implementations, the frequency domain spacing may be represented by a quantity of PREs. In some other implementations, the frequency domain spacing may be represented by a frequency domain width (for example, hertz (Hz)).

The following describes a method for determining the frequency resource of the first request with reference to FIG. 5 by using an example in which the first information is used to indicate the frequency domain spacing between the frequency resource of the SSB and the frequency resource of the first request and the transmission periodicity of the first request.

With reference to FIG. 5, it is assumed that the frequency domain spacing between the frequency resource of the SSB and the frequency resource of the first request is the frequency domain spacing between the lower limit PRE of the SSB and the lower limit PRE of the first request. The frequency domain spacing is represented by the frequency domain width, and is configured by using Offset in FIG. 5. The lower limit PRE of the first request may be determined based on Kssb and Offset that are determined based on the parameter SSB-SubcarrierOffset of the MIB carried in the SSB, and then the frequency resource for transmitting the first request may be determined based on a frequency bandwidth required for transmitting the first request.

In some implementations, the time resource for transmitting the first request may be a time domain location of the first request.

In some implementations, the time domain location of the first request may be a start time domain location of the first request, for example, a start frame location of the first request. In some implementations, the time domain location of the first request may be an end time domain location of the first request, for example, an end slot location of the first request. In some other implementations, the time domain location of the first request may be an index of a time domain location of the first request, for example, an index of a slot of the first request, such as a slot 0 (slot0) or a slot 1 (slot1).

The following describes a method for determining the time resource of the first request by using an example in which the first information is used to indicate the time resource for transmitting the first request and the transmission periodicity of the first request.

It is assumed that the time resource for transmitting the first request is the start frame location of the first request and is configured by using YYY, and the transmission periodicity of the first request is configured by using XXX. In this case, it may be determined that the time resource of the first request is YYY+XXX, YYY+2*XXX, . . . , and the like.

Embodiment 5: The first information includes information related to a part of parameters in first system information, or information related to a physical resource in which first system information is located.

In some implementations, the information related to the part of parameters or the information related to the physical resource is used for determining the transmission resource for transmitting the first request, and/or the sequence information of the first request. For example, the first system information may be referred to as “SIB0.5”, and information related to a physical resource of the SIB0.5 is a transmission resource of the SIB0.5.

In some implementations, the first system information may be periodically transmitted. Certainly, in this embodiment of the present application, the first system information may alternatively be aperiodically transmitted.

In some implementations, the transmission periodicity of the first system information may be defined based on a protocol.

In some implementations, addressing transmission is performed on the first system information by using a predefined radio network temporary identity (radio network temporary identity, RNTI).

In some implementations, the predefined RNTI may be a newly defined RNTI based on a protocol. In some other implementations, the predefined RNTI may be an SI-RNTI.

In some implementations, the first system information is indicated by using DCI. For example, it is assumed that the first system information is a SIB0.5, the network device (for example, a base station) indicates, by using a remaining bit in the DCI, whether a SIB0.5 or a SIB1 is currently transmitted.

In this embodiment of the present application, a manner of determining, based on the information related to the part of parameters in the first system information or the information related to the physical resource in which the first system information is located, the transmission resource for transmitting the first request is not limited. In some implementations, the information related to the part of parameters in the first system information may directly indicate the transmission resource for transmitting the first request. In some other implementations, the information related to the physical resource in which the first system information is located may indirectly indicate the transmission resource for transmitting the first request.

In some implementations, the information related to the part of parameters in the first system information directly indicates the transmission resource of the first request. It may be understood that the first system information carries a fourth parameter, and the fourth parameter is used to indicate the transmission resource for transmitting the first request. For example, the fourth parameter is used to indicate the time resource of the first request.

In some implementations, the information related to the physical resource in which the first system information is located indirectly indicates the transmission resource of the first request. It may be understood that the transmission resource of the first system information is associated with a part of the transmission resource of the first request. For example, the frequency resource of the first system information is associated with the frequency resource of the first request.

In some other implementations, the information related to the physical resource in which the first system information is located indirectly indicates the transmission resource of the first request. It may be understood that the transmission resource of the first system information is associated with all of the transmission resource of the first request. For example, a frequency resource, a time resource, and a code resource of the first system information are all associated with the frequency resource, the time resource, and a code resource of the first request.

In some implementations, a part of the transmission resource for transmitting the first system information is associated with a part of the transmission resource for transmitting the first request, the first system information carries the fourth parameter, and the fourth parameter is used to indicate the part of the transmission resource for transmitting the first request. For example, the fourth parameter is used to indicate the time resource for transmitting the first request, and the frequency resource for transmitting the first system information is associated with the frequency resource for transmitting the first request.

In some implementations, the first system information carries only a fifth parameter, and the fifth parameter is used to indicate the transmission resource for transmitting the first request and the sequence information of the first request, which facilitates saving the transmission resource for transmitting the first system information.

In some implementations, the transmission resource of the first system information is determined based on the first parameter and/or the common CORESET indicated by the MIB.

In some implementations, the transmission resource of the first system information is determined based on the first parameter and/or the common CORESET indicated by the MIB. It may be understood that a monitoring transmission resource set of the first system information may be determined based on the first parameter and/or the common CORESET indicated by the MIB, and the transmission resource of the first system information may be determined based on the monitoring transmission resource set of the first system information. For example, the first parameter is Kssb indicated by the parameter SSB-SubcarrierOffset of the MIB, and the value of Kssb is a valid value. The common CORESET information is determined based on Kssb and the parameter pdcch-ConfigSIB1 of the MIB. The common CORESET information is the monitoring transmission resource set of the first system information. The DCI may be blindly detected based on the common CORESET information. The DCI indicates the transmission resource of the first system information.

With reference to FIG. 6, the following describes, by using an example, a method in which the first information includes the information related to the part of parameters in the first system information. FIG. 6 includes steps S610 and S620.

It is assumed that the first system information is the SIB0.5, the first parameter is Kssb (the value of the parameter is a valid value), the transmission resource of the SIB0.5 is determined based on Kssb and the common CORESET, the SIB0.5 carries only the fifth parameter, and the first information includes the fifth parameter.

In Step S610, transmitting, by the network device, SSB&MIB.

The terminal device receives the SSB transmitted by the network device. The SSB carries the MIB. The terminal device reads valid Kssb based on the MIB. The common CORESET information is determined based on the value of Kssb and the parameter pdcch-ConfigSIB1 of the MIB. The DCI is blindly detected based on the common CORESET information. The DCI indicates the transmission resource of the SIB0.5.

In step S620, receiving, by the terminal device, the SIB0.5.

The terminal device receives the SIB0.5 transmitted by the network device, and determines, based on the fifth parameter of the SIB0.5, the transmission resource for transmitting the first request and the sequence information of the first request.

Embodiment 6: The first information is system information of a target cell.

In some implementations, the first information is the system information of the target cell, and the target cell is different from a cell corresponding to the SIB1. For example, the target cell may be a neighboring cell of the cell corresponding to the SIB1.

In some implementations, the target cell is a cell that assists the terminal device in transmitting the first request. Therefore, the target cell may be referred to as an “assisting cell”, and the system information of the target cell may also be referred to as “assisting information”.

In some other implementations, because the SIB1 may be requested by the terminal device on demand, energy of the cell corresponding to the SIB1 is saved in comparison with periodic transmission of the SIB1. Therefore, the cell corresponding to the SIB1 may be referred to as a “network energy saving (network energy saving, NES) cell”.

In embodiments of the present application, the system information of the target cell is not limited. In some implementations, the system information of the target cell is a separate SIB, for example, a new SIB19 defined by a protocol. In some implementations, the system information of the target cell is a data structure added to an existing SIB, for example, a data structure added to a SIB2.

System information of one target cell may be first information corresponding to one NES cell in a plurality of NES cells. To facilitate determining the NES cell corresponding to the first information, in some implementations, the first information further includes information used to indicate an association relationship between the system information of the target cell and the cell corresponding to the SIB1.

In some implementations, the information used to indicate the association relationship between the system information of the target cell and the cell corresponding to the SIB1 is carried in a field of the system information of the target cell. For example, the system information of the target cell is a SIB19, and one field of the SIB19 indicates an association relationship between the SIB19 and the cell corresponding to the SIB1.

In some implementations, the information used to indicate the association relationship between the system information of the target cell and the cell corresponding to the SIB1 may be information that can indicate the cell corresponding to the SIB1.

In some implementations, the information indicating the cell corresponding to the SIB1 is a physical cell identifier (physical cell identifier, PCI) of the cell corresponding to the SIB1. In some other implementations, the information indicating the cell corresponding to the SIB1 is a frequency point of the cell corresponding to the SIB1.

In embodiments of the present application, a manner of obtaining the target cell is not limited. In some implementations, the target cell may be searched by the terminal device itself. For example, the terminal device searches for a neighboring cell by itself. In some other implementations, the target cell may be indicated by the cell corresponding to the SIB1.

In some implementations, the cell corresponding to the SIB1 indicates the target cell. It may be understood that the terminal device receives first indication information transmitted by the network device in the cell corresponding to the SIB1, and the first indication information is used to indicate the target cell.

In some implementations, the first indication information is MIB information transmitted in the cell corresponding to the SIB1.

By using an example in which the first indication information is the MIB information transmitted in the cell corresponding to the SIB1, the following describes a method for indicating the target cell by using the first indication information.

It is assumed that the network device transmits the MIB information in the cell corresponding to the SIB1, and the terminal device receives the MIB information and obtains Kssb based on the parameter SSB-SubcarrierOffset of the MIB. The terminal device performs a modulo operation on a PCI of the cell corresponding to the SIB1, and determines the target cell based on the value of Kssb and an operation result. For example, if the value of Kssb is 12, the terminal device considers a cell whose PCI mod 4=0 as the target cell; if the value of Kssb is 13, the terminal device considers a cell whose PCI mod 4=1 as the target cell; if the value of Kssb is 14, the terminal device considers a cell whose PCI mod 4=2 as the target cell; and if the value of Kssb is 15, the terminal device considers a cell whose PCI mod 4=3 as the target cell.

With reference to Embodiment 1 to Embodiment 6, the foregoing describes the first information in embodiments of the present application. In some scenarios, Embodiment 1 to Embodiment 6 may be used separately. In other scenarios, Embodiment 1 to Embodiment 6 may be used in combination.

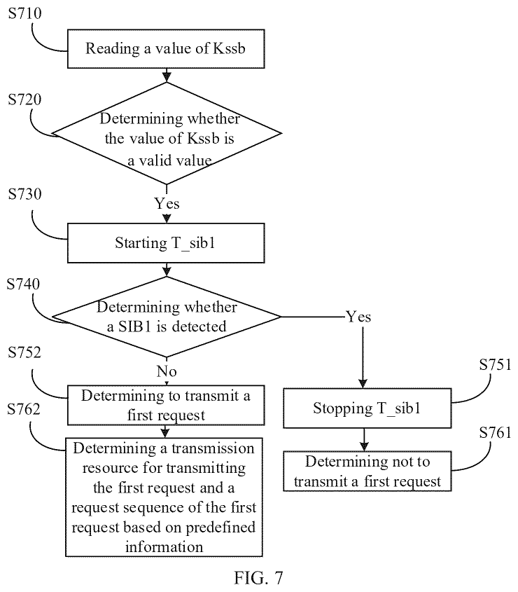

The following describes a solution of combining Embodiment 2 and Embodiment 4 of the first information by using an example with reference to FIG. 7. FIG. 7 includes Step S710 to Step S762.

It is assumed that the first timer is T_sib1, the first parameter is Kssb, and the predefined information includes the frequency domain spacing (configured by using Offset) between the lower limit PRE of the SSB and the lower limit PRE of the first request, the transmission periodicity (configured by using XXX) of the first request, the start frame location (configured by using YYY) of transmitting the first request, the frequency bandwidth required for transmitting the first request, and the sequence information of the first request.

In Step S710, reading, by the terminal device, a value of Kssb.

The terminal device reads the value of Kssb based on the received parameter SSB-SubcarrierOffset of the MIB.

In Step S720, determining, by the terminal device, whether the value of Kssb is a valid value.

The terminal device determines, based on a frequency range of the terminal device, whether the value of Kssb is a valid value. For the FR 1, if the value of Kssb is a value in 0-11, the value of Kssb is a valid value. For the FR 2, if the value of Kssb is a value in 0-23, the value of Kssb is a valid value. When the value of Kssb is a valid value, the terminal device goes to Step S730, and further needs to obtain the common CORESET information based on the parameter pdcch-ConfigSIB1 of the MIB.

In Step S730, starting, by the terminal device, T_sib1.

The terminal device determines the duration of T_sib1 based on the first information, and starts T_sib1.

In Step S740, determining, by the terminal device, whether the SIB1 is detected.

During running of the first timer T_sib1, the terminal device monitors, based on the SI-RNTI, the DCI indicated by the common CORESET information, and monitors the SIB1 based on information indicated by the DCI. If the terminal device detects the SIB1, Step S751 is performed. If T_sib1 expires, the terminal device determines that the transmission manner of the SIB1 is triggering transmission of the SIB1 based on the request of the terminal device, and goes to Step S752.

In Step S751, stopping, by the terminal device, T_sib1.

The terminal device stops T_sib1 and reads the SIB1.

In Step S761, determining, by the terminal device, not to transmit the first request.

The terminal device has received the SIB1, and therefore determines not to transmit the first request.

In Step S752, determining, by the terminal device, to transmit the first request.

The terminal device has determined that the transmission manner of the SIB1 is triggering transmission of the SIB1 based on the request of the terminal device, and may determine to transmit the first request.

In Step S762, determining, by the terminal device, based on the predefined information, the transmission resource for transmitting the first request and the sequence information of the first request.

The terminal device may determine, based on Kssb and Offset, the lower limit PRE of the first request, and then may determine the frequency resource of the first request based on the frequency bandwidth required for transmitting the first request; and may determine, based on YYY and XXX, that the time resource of the first request is YYY+XXX, YYY+2*XXX, . . . , and the like.

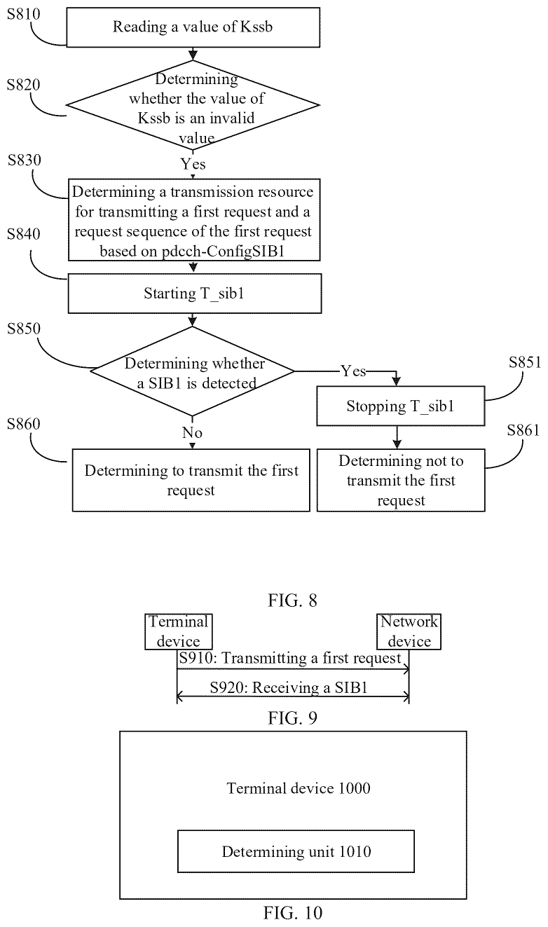

The following describes a solution of combining Implementation 1-1 and Embodiment 2 of the first information by using an example with reference to FIG. 8. FIG. 8 includes Step S810 to Step S861.

It is assumed that the first timer is T_sib1, the first parameter is Kssb, the second parameter is pdcch-ConfigSIB1, and pdcch-ConfigSIB1 may be used for determining the transmission resource for transmitting the first request and a request sequence of the first request.

In Step S810, reading, by the terminal device, a value of Kssb.

The terminal device reads the value of Kssb based on the received parameter SSB-SubcarrierOffset of the MIB.

In Step S820, determining, by the terminal device, whether the value of Kssb is an invalid value.

The terminal device determines, based on a frequency range of the terminal device, whether the value of Kssb is an invalid value. For the FR 1, if the value of Kssb is a value in 12-15, the value of Kssb is an invalid value. For the FR 2, if the value of Kssb is a value in 24-31, the value of Kssb is an invalid value. When the value of Kssb is an invalid value, the terminal device determines that the transmission manner of the SIB1 is triggering transmission of the SIB1 based on the request of the terminal device, and goes to Step S830.

In Step S830, determining, by the terminal device, based on pdcch-ConfigSIB1, the transmission resource for transmitting the first request and the request sequence for transmitting the first request.

Based on read pdcch-ConfigSIB1 of the received MIB, the terminal device determines, based on pdcch-ConfigSIB1, the transmission resource for transmitting the first request and the request sequence of the first request.

In Step S840, starting, by the terminal device, T_sib1.

The terminal device determines the duration of T_sib1 based on the first information, and starts T_sib1.

In Step S850, determining, by the terminal device, whether the SIB1 is detected.

During running of the first timer T_sib1, the terminal device obtains the common CORESET information based on the parameter pdcch-ConfigSIB1 of the MIB, monitors, based on an SI-RNTI, the DCI indicated by the common CORESET information, and monitors, based on information indicated by the DCI, an SIB1 requested by another terminal device on demand. If the terminal device detects the SIB1, the terminal device goes to Step S851. If T_sib1 expires, the terminal device goes to Step S860.

In Step S851, stopping, by the terminal device, T_sib1.

The terminal device stops T_sib1 and reads the SIB1.

In Step S861, determining, by the terminal device, not to transmit the first request.

The terminal device has received the SIB1, and therefore determines not to transmit the first request.

In Step S860, determining, by the terminal device, to transmit the first request.

The terminal device has determined that the transmission manner of the SIB1 is triggering transmission of the SIB1 based on the request of the terminal device, and the terminal device has not received the SIB1. In this case, the terminal device may determine to transmit the first request.

The foregoing describes a method for determining, by the terminal device, whether to transmit the first request. The following describes a method for transmitting the first request and receiving the SIB1 by the terminal device with reference to FIG. 9.

In Step S910, transmitting, by the terminal device, the first request to the network device.

In embodiments of the present application, a transmission opportunity of the first message is not limited. In some implementations, the terminal device transmits the first request in a random access process. For example, the terminal device in an idle (IDLE) state or an inactive (INACTIVE) state transmits the first request by using a message 1 or a message 3 in the random access process. Certainly, in embodiments of the present application, the terminal device may alternatively transmit the first request by using another signal.

In Step S920, in response to the first request, receiving, by the terminal device, the SIB1 transmitted by the network device.

In some implementations, the terminal device may receive, based on the transmission occasion of the first request, the SIB1 transmitted by the network device. For example, if the terminal device transmits the first request by using the message 1, the terminal device may monitor a common CORESET based on a random access radio network temporary identifier (random access radio network temporary identifier, RA-RNTI), to receive a message 2. After receiving the message 2, the terminal device considers that the network device successfully receives the first request, and the terminal device may start to receive the requested SIB1. For another example, if the terminal device transmits the first request by using the message 3, the terminal device may monitor a common CORESET based on a temporary radio network temporary identifier (temporary radio network temporary identifier, Temp-RNTI), to receive a message 4. After receiving the message 4, the terminal device considers that the network device successfully receives the first request, and the terminal device may start to receive the requested SIB1.

In some implementations, a beam (beam) for transmitting the first request matches a beam for transmitting the SIB1.

In some implementations, that the beam for transmitting the first request matches the beam for transmitting the SIB1 may be understood as that the beam for transmitting the first request and the beam for transmitting the SIB1 are a same beam. Therefore, the terminal device may monitor the SIB1 on the specific beam for transmitting the first request, which facilitates saving power consumption of the terminal device. Certainly, in embodiments of the present application, the terminal device may monitor the SIB1 on all beams.

In some implementations, the first request is associated with a second timer, and the second timer is used to indicate a time for retransmitting the first request. For example, the second timer may be referred to as “T_nextreqsib1”.

In some implementations, a length of the second timer is defined based on a protocol.

In some other implementations, the length of the second timer may be N times the transmission periodicity of the SIB1, where a value of N may be defined based on a protocol.

By using an example, the following describes a method in which the second timer is used to indicate the time for retransmitting the first request.

It is assumed that the second timer is T_nextreqsib1. After transmitting the first request, the terminal device starts the second timer T_nextreqsib1, and starts to detect the SIB1. If the terminal device successfully detects the SIB1, the terminal device stops the second timer T_nextreqsib1. If the second timer T_nextreqsib1 expires, and the terminal device still fails to detect the SIB1, the terminal device transmits the first request to the network device again, to request the network device to transmit the SIB1.

The method embodiments of the present application are described in detail above with reference to FIG. 1 to FIG. 9. Apparatus embodiments of the present application are described in detail below with reference to FIG. 10 to FIG. 12. It should be understood that the description of the method embodiments corresponds to the description of the apparatus embodiments, and therefore, for a part that is not described in detail, reference may be made to the foregoing method embodiments.

FIG. 10 is a schematic diagram of a terminal device according to an embodiment of the present application. The terminal device 1000 shown in FIG. 10 includes a determining unit 1010.

The determining unit 1010 is configured to determine whether to transmit a first request, where the first request is used to request a network device to transmit a SIB1, where the first request is associated with first information, and the first information is used for one or more of the following: determining a transmission manner of the SIB1; determining a transmission resource for transmitting the first request; or determining sequence information of the first request.

In some implementations, the transmission manner of the SIB1 includes: triggering transmission of the SIB1 based on a request of the terminal device, and/or triggering transmission of the SIB1 based on a periodicity.

In some implementations, the first information includes a first parameter, and the first parameter is used for determining the transmission manner of the SIB1.

In some implementations, the first parameter is used to indicate a frequency domain offset between a transmission resource of a synchronization signal broadcast channel block SSB and a reference resource.

In some implementations, the first information is used to indicate a duration of a first timer, and the first timer is used to record a duration in which the terminal device monitors the SIB1.

In some implementations, starting of the first timer is triggered based on a value of the first parameter; or starting of the first timer is triggered based on a MIB read by the terminal device.

In some implementations, the first timer is associated with a first frequency range, and the first frequency range belongs to a plurality of frequency ranges, and durations of first timers associated with different frequency ranges in the plurality of frequency ranges are different; or durations of first timers associated with different frequency ranges in the plurality of frequency ranges are the same.

In some implementations, the first information is carried in a dedicated field in a MIB.

In some implementations, if a value of the first parameter is an invalid value, the transmission manner of the SIB1 is triggering transmission of the SIB1 based on a request of the terminal device; and/or if the value of the first parameter is a valid value, the transmission manner of the SIB1 is triggering transmission of the SIB1 based on a periodicity.

In some implementations, if a value of the first parameter is an invalid value, the first information includes a second parameter that is in the MIB and that is used for configuring the SIB1, and the second parameter is used for determining the transmission resource for transmitting the first request, and/or determining the sequence information of the first request.

In some implementations, the transmission resource of the first request is aligned with a transmission resource of an SSB in time domain or frequency domain.

In some implementations, the first parameter belongs to one of a plurality of first parameters obtained by the terminal device, and if values of the plurality of first parameters are different, the transmission manner of the SIB1 is triggering transmission of the SIB1 based on a request of the terminal device.

In some implementations, if a value of the first parameter is a valid value, the first information includes a second parameter that is in a MIB and that is used for configuring the SIB1, and the second parameter is used for determining the transmission resource for transmitting the first request, and/or determining the sequence information of the first request.

In some implementations, the first information is used for determining the transmission resource for transmitting the first request, and/or the sequence information of the first request, and the first information is predefined information.

In some implementations, the first information is used to indicate one or more of the following: a frequency domain spacing between a frequency resource of the SSB and a frequency resource of the first request; a transmission periodicity of the first request; a time resource for transmitting the first request; or a frequency bandwidth required for transmitting the first request.

In some implementations, the first information includes first system information, and the first system information is used for determining the transmission resource for transmitting the first request, and/or the sequence information of the first request.

In some implementations, the first system information carries a fourth parameter, and the fourth parameter is used to indicate the transmission resource for transmitting the first request.

In some implementations, the transmission resource of the first system information is associated with a part or all of the transmission resource of the first request.

In some implementations, a transmission resource of the first system information is determined based on a first parameter and/or a common CORESET indicated by a MIB.

In some implementations, the first information is system information of a target cell, and the target cell is different from a cell corresponding to the SIB1.

In some implementations, the first information further includes information used to indicate an association relationship between the system information of the target cell and the cell corresponding to the SIB1.

In some implementations, the terminal device further includes: a receiving unit, receiving first indication information transmitted by the network device in the cell corresponding to the SIB1, where the first indication information is used to indicate the target cell.

In some implementations, the first indication information is MIB information transmitted in the cell corresponding to the SIB1.

In some implementations, the terminal device further includes: a transmitting unit, transmitting the first request to the network device; and a receiving unit, in response to the first request, further receiving the SIB1 transmitted by the network device.

In some implementations, a beam for transmitting the first request matches a beam for transmitting the SIB1.

In some implementations, the first request is associated with a second timer, and the second timer is used to indicate a time for retransmitting the first request.

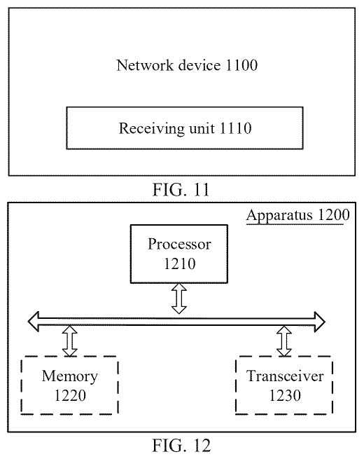

FIG. 11 is a schematic diagram of a network device according to an embodiment of the present application. The network device 1100 shown in FIG. 11 includes a receiving unit 1110.

The receiving unit 1110 is configured to receive a first request transmitted by a terminal device, where the first request is used to request the network device to transmit a SIB1, where the first request is associated with first information, and the first information is used for one or more of the following: determining a transmission manner of the SIB1; determining a transmission resource for transmitting the first request; or determining sequence information of the first request.

In some implementations, the transmission manner of the SIB1 includes: triggering transmission of the SIB1 based on a request of the terminal device, and/or triggering transmission of the SIB1 based on a periodicity.

In some implementations, the first information includes a first parameter, and the first parameter is used for determining the transmission manner of the SIB1.

In some implementations, the first parameter is used to indicate a frequency domain offset between a transmission resource of a synchronization signal broadcast channel block SSB and a reference resource.

In some implementations, the first information is used to indicate a duration of a first timer, and the first timer is used to record a duration in which the terminal device monitors the SIB1.

In some implementations, starting of the first timer is triggered based on a value of the first parameter; or starting of the first timer is triggered based on a MIB read by the terminal device.

In some implementations, the first timer is associated with a first frequency range, and the first frequency range belongs to a plurality of frequency ranges, and durations of first timers associated with different frequency ranges in the plurality of frequency ranges are different; or durations of first timers associated with different frequency ranges in the plurality of frequency ranges are the same.

In some implementations, the first information is carried in a dedicated field in a MIB.

In some implementations, if a value of the first parameter is an invalid value, the transmission manner of the SIB1 is triggering transmission of the SIB1 based on a request of the terminal device; and/or if the value of the first parameter is a valid value, the transmission manner of the SIB1 is triggering transmission of the SIB1 based on a periodicity.

In some implementations, if a value of the first parameter is an invalid value, the first information includes a second parameter that is in the MIB and that is used for configuring the SIB1, and the second parameter is used for determining the transmission resource for transmitting the first request, and/or determining the sequence information of the first request.

In some implementations, the transmission resource of the first request is aligned with a transmission resource of an SSB in time domain or frequency domain.

In some implementations, the first parameter belongs to one of a plurality of first parameters obtained by the terminal device, and if values of the plurality of first parameters are different, the transmission manner of the SIB1 is triggering transmission of the SIB1 based on a request of the terminal device.

In some implementations, if a value of the first parameter is a valid value, the first information includes a second parameter that is in a MIB and that is used for configuring the SIB1, and the second parameter is used for determining the transmission resource for transmitting the first request, and/or determining the sequence information of the first request.

In some implementations, the first information is used for determining the transmission resource for transmitting the first request, and/or the sequence information of the first request, and the first information is predefined information.

In some implementations, the first information is used to indicate one or more of the following: a frequency domain spacing between a frequency resource of the SSB and a frequency resource of the first request; a transmission periodicity of the first request; a time resource for transmitting the first request; or a frequency bandwidth required for transmitting the first request.

In some implementations, the first information includes first system information, and the first system information is used for determining the transmission resource for transmitting the first request, and/or the sequence information of the first request.

In some implementations, the first system information carries a fourth parameter, and the fourth parameter is used to indicate the transmission resource for transmitting the first request.

In some implementations, the transmission resource of the first system information is associated with a part or all of the transmission resource of the first request.

In some implementations, a transmission resource of the first system information is determined based on a first parameter and/or a common CORESET indicated by a MIB.

In some implementations, the first information is system information of a target cell, and the target cell is different from a cell corresponding to the SIB1.

In some implementations, the first information further includes information used to indicate an association relationship between the system information of the target cell and the cell corresponding to the SIB1.

In some implementations, the network device further includes: a transmitting unit, transmitting first indication information to the terminal device in the cell corresponding to the SIB1, where the first indication information is used to indicate the target cell.

In some implementations, the first indication information is MIB information transmitted in the cell corresponding to the SIB1.

In some implementations, the network device further includes: a transmitting unit, further configured to: in response to the first request, transmit the SIB1 to the terminal device.

In some implementations, a beam for transmitting the first request matches a beam for transmitting the SIB1.

In some implementations, the first request is associated with a second timer, and the second timer is used to indicate a time for retransmitting the first request.

In an optional embodiment, the determining unit 1010 may be a processor 1210. The terminal device 1000 may further include a transceiver 1230 and a memory 1220. Details are shown in FIG. 12.

In an optional embodiment, the receiving unit 1110 may be a transceiver 1230. The network device 1100 may further include a processor 1210 and a memory 1220. Details are shown in FIG. 12.

FIG. 12 is a schematic diagram of a structure of a communications apparatus according to an embodiment of the present application. Dashed lines in FIG. 12 indicate that a unit or module is optional. The apparatus 1200 may be configured to implement the method described in the foregoing method embodiments. The apparatus 1200 may be a chip, a terminal device, or a network device.

The apparatus 1200 may include one or more processors 1210. The processor 1210 may support the apparatus 1200 in implementing the method described in the foregoing method embodiments. The processor 1210 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program, and the program may be executed by the processor 1210, so that the processor 1210 executes the method described in the foregoing method embodiments. The memory 1220 may be separate from or integrated into the processor 1210.

The apparatus 1200 may further include a transceiver 1230. The processor 1210 may communicate with another device or chip through the transceiver 1230. For example, the processor 1210 may transmit data to and receive data from another device or chip through the transceiver 1230.

An embodiment of the present application further provides a computer-readable storage medium for storing a program. The computer-readable storage medium may be applied to the terminal or the network device provided in embodiments of the present application, and the program causes a computer to execute the methods performed by the terminal or the network device in various embodiments of the present application.

An embodiment of the present application further provides a computer program product. The computer program product includes a program. The computer program product may be applied to the terminal or the network device provided in embodiments of the present application, and the program causes a computer to perform the methods performed by the terminal or the network device in various embodiments of the present application.

An embodiment of the present application further provides a computer program. The computer program may be applied to a terminal or a network device provided in embodiments of the present application, and the computer program causes a computer to execute the methods performed by the terminal or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained through A; or may mean that A indirectly indicates B, for example, A indicates C, and B may be obtained by using C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “pre-configured” may be implemented by pre-storing corresponding code, tables, or other forms that may be used to indicate related information in devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system. This is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented through software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
determining, by a terminal device, whether to transmit a first request, wherein the first request is used to request a network device to transmit a system information block 1 (SIB1), and
the first request is associated with first information, and the first information is used for one or more of following:
determining a transmission manner of the SIB1;
determining a transmission resource for transmitting the first request; or
determining sequence information of the first request.

2. The method according to claim 1, wherein the transmission manner of the SIB1 is triggered based on a request of the terminal device or a periodicity.

3. The method according to claim 1, wherein the first information comprises a first parameter, and the first parameter is used for determining the transmission manner of the SIB1.

4. The method according to claim 3, wherein the first parameter is Kssb and the first parameter indicates a frequency domain offset between a transmission resource of a synchronization signal/physicalbroadcast channel block (SSB) and a reference resource.

5. The method according to claim 1, wherein the first information indicates a duration of a first timer, and the first timer is used to record a duration in which the terminal device monitors the SIB1.

6. The method according to claim 4, wherein if a value of the first parameter is an invalid value, the transmission manner of the SIB1 is triggering transmission of the SIB1 based on a request of the terminal device; or
if the value of the first parameter is a valid value, the transmission manner of the SIB1 is triggering transmission of the SIB1 based on a periodicity.

7. The method according to claim 1, wherein, the first information comprises a second parameter that is used for configuring the SIB1; and wherein
the second parameter is used for determining at least one of the transmission resource for transmitting the first request or the sequence information of the first request.

8. The method according to claim 4, wherein the first parameter belongs to one of a plurality of first parameters obtained by the terminal device, and when values of the plurality of first parameters are different, the transmission manner of the SIB1 is triggering transmission of the SIB1 based on a request of the terminal device.

9. The method according to claim 8, wherein the first information comprises a second parameter that is used for configuring the SIB1, and wherein
the second parameter is used for determining at least one of the transmission resource for transmitting the first request or the sequence information of the first request.

10. The method according to claim 1, wherein the first information indicates one or more of following:
a frequency domain spacing between a frequency resource of an SSB and a frequency resource of the first request;
a transmission periodicity of the first request;
a time resource for transmitting the first request; or
a frequency bandwidth required for transmitting the first request.

11. The method according to claim 1, wherein the first information comprises information related to a part of parameters in first system information, or information related to a physical resource in which first system information is located, and the information related to the part of parameters or the information related to the physical resource is used for determining at least one of the transmission resource for transmitting the first request or the sequence information of the first request.

12. The method according to claim 11, wherein the first system information carries a fourth parameter, and the fourth parameter indicates the transmission resource for transmitting the first request.

13. The method according to claim 1, wherein the first information is system information of a target cell, and the target cell is different from a cell corresponding to the SIB1.

14. The method according to claim 13, wherein the method further comprises:
receiving, by the terminal device, first indication information from the network device in the cell corresponding to the SIB1, wherein the first indication information indicates the target cell.

15. The method according to claim 1, wherein the method further comprises:
transmitting, by the terminal device, the first request to the network device; and
in response to the first request, receiving, by the terminal device, the SIB1 transmitted by the network device.

16. The method according to claim 15, wherein a beam for transmitting the first request matches a beam for transmitting the SIB1.

17. The method according to claim 1, wherein the first request is associated with a second timer, and the second timer is used to indicate a time for retransmitting the first request.

18. A wireless communication method, comprising:
receiving, by a network device, a first request from a terminal device, wherein the first request is used to request the network device to transmit a system information block 1 (SIB1), and
the first request is associated with first information, and the first information is used for one or more of following:
determining a transmission manner of the SIB1;
determining a transmission resource for transmitting the first request; or
determining sequence information of the first request.

19. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
determining, by a terminal device, whether to transmit a first request, wherein the first request is used to request a network device to transmit a system information block 1 (SIB1), and
the first request is associated with first information, and the first information is used for one or more of following:
determining a transmission manner of the SIB1;
determining a transmission resource for transmitting the first request; or
determining sequence information of the first request.

20. The apparatus according to claim 19, wherein the transmission manner of the SIB1 is triggered based on a request of the terminal device or a periodicity.
